(19) United States
(12) Patent Application Publication
(10) Pub. No.: US 2026/0148058 A1
(43) Pub. Date: May 28, 2026

(54) SYSTEM AND METHOD FOR DUPLICATE CRASH IDENTIFICATION

(71) Applicant: SAP SE, Walldorf (DE)

(72) Inventors: Yang XU, Xi'an (CN); Yong LI, Xi'an (CN); Qiao-luan XIE, Xi'an (CN); Sanghun KANG, Yeongdeunpo-Gu (KR); Sunghun KIM, Gangnam-Ku (KR); Chao LIU, Xi'an (CN)

(21) Appl. No.: 18/958,113

(22) Filed: Nov. 25, 2024

(51) Int. Cl. G06F 11/07

(52) U.S. Cl. CPC G06N 3/08

(57) ABSTRACT

According to some embodiments, systems and methods are provided including receiving a crash dump file; extracting a call stack from the received crash dump file, wherein the call stack includes one or more functions, the functions having ordered positions in the call stack; converting the extracted call stack to natural language sentences; converting the natural languages sentences to a first call stack matrix; receiving the first call stack matrix and a second call stack matrix at a crash model, wherein the crash model is a Siamese neural network model; determining a similarity score for the first call stack matrix and the second call stack matrix; and determining whether the first call stack matrix and the second call stack matrix represent duplicate crashes based on the similarity score. Numerous other aspects are provided.

### BACKGROUND

A database cloud platform hosts numerous applications based on database cloud platform instances. A non-exhaustive example of a database cloud platform is SAP's HANA® cloud platform. An instance refers to a single database that can be accessed by cloud applications or other applications. Each instance has its own resources, such as memory and work processes. The instances may be used by different external clients. Crash failures may occur in different instances. A crash failure occurs when the application stops functioning properly and exits, resulting all transactions being stopped. In some cases the crash failures that occur in the different instances may be the result of a same root (primary) cause. Crash failures having a same root cause may be referred to as duplicate crash failures.

Additionally, duplicate crash failures may occur for internal clients, and in particular, during internal testing of a given database for which there are different versions of that given database. With respect to the internal testing, each time new code (e.g., a code patch) is developed for an application, it may be pushed into a data repository, which may automatically trigger some testing of the code (e.g., the code patch). The testing process identifies any bugs (coding errors) in the code that may result in a crash failure.

In some cases, execution of the code patch during the test may cause the application to experience a crash failure. In some of those crash failure cases, a crash failure in one application causes a crash failure in another application executing for its respective test. Multiple crash failures may be identified during the testing process. In the case of a crash failure, a crash error message is generated and information about the crash is added to a crash log. In the case of the testing of two codes, they both may experience a crash failure, and have different crash error messages and different crash log entries. However, the root cause of the crash may be the same. In particular, the crash failure of a first code caused the crash failure of a second code.

Conventionally, the crashes are manually reviewed one-by-one by an expert. In some cases the expert is a developer who manually checks the crashes. However, the developer may only be familiar with their code/application/version and may be unable to identify a crash dump pattern (e.g., the root cause) that occurs in crashes for other codes/applications/versions. For example, the developer of the second code may not be able to identify the first code as causing the crash of the second code. While the second code did not actually crash because of a problem with itself and the process for passing the testing phase may continue for the second code, the release of the second code will be delayed while the tests are restarted and the cause of the crash identified, which is undesirable. Eventually, it may be determined that both crashes are the result of the same root cause, and the crashes will be marked with one existing known bug. Identifying these duplicate crash failures is a time-consuming task requiring specialized expertise. The complexity is compounded when there are similar failures across different versions of an instance.

It would be desirable to automatically detect duplicate crash failures.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings

FIG. 1 is a block diagram of an architecture according to some embodiments.

FIG. 2 is a flow diagram of a process according to some embodiments.

FIG. 3 is a flow diagram of a process according to some embodiments.

FIG. 4A illustrates a non-exhaustive example of data pre-processing according to some embodiments.

FIG. 4B illustrates a continuation of the non-exhaustive example of data pre-processing in FIG. 4A according to some embodiments.

FIG. 4C illustrates a continuation of the non-exhaustive example of data pre-processing in FIG. 4B according to some embodiments.

FIG. 5 illustrates the non-exhaustive example of FIG. 4C with additional data pre-processing according to some embodiments.

FIG. 6 is a flow diagram of a process according to some embodiments.

FIG. 7 is a block diagram including a call stack matrix according to some embodiments.

FIG. 8 is a flow diagram of a process according to some embodiments.

FIG. 9 is a block diagram of a crash model according to some embodiments.

FIG. 10 is a block diagram of a model pipeline according to some embodiments.

FIG. 11 is a user interface for presenting an output according to some embodiments.

FIG. 12 is a block diagram of a hardware environment according to some embodiments.

Throughout the drawings and detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, a duplicate crash failure is two or more crashes caused by the same bug (e.g., coding error). The crash occurs when the application stops functioning properly and exits, resulting in the stop of all transactions of the application. In some instances, the crash may be due to another application crashing. Identifying the duplicate crash failure is a time-consuming task requiring specialized expertise. For example, the expert may need to analyze the raw crash dump files, referred to as crash logs to identify patterns, analyze the patterns, and then identify any duplicate crashes. The complexity in identifying the duplicate crash failures is compounded when confronted with similar failures across different database versions.

To address these problems, a duplicate crash identification framework or system provides for the automatic identification of duplicate crash failures. Pursuant to embodiments, raw crash dump files (crash logs) are received. The crash log may include information like the call stack and the name of the crashed module. A call stack is a data structure that keeps track of all of the functions that are called and executed in an application in order. The call stack stores information about the called functions, their arguments, local variables, and the order in which the functions were called/executed. The first line of the call stack is the current function that the application is executing during the crash. The next functions are the functions that have led to calling the current function.

In embodiments, the crash logs are transformed into a structured natural language format enabling the utilization of large language models (LLM) for semantic understanding of the call stacks, via the conversion of the call stack into a call stack matrix. A LLM is a type of artificial intelligence (AI) program that can recognize and generate text. Pursuant to embodiments, the LLM uses embeddings/vectors to represent the text of the natural language version of the call stack in a way that can be processed by machine learning algorithms. The LLM, combined with deep learning modules, captures complex relationships within the call stacks. The output of the LLM (the call stack matrix) is next processed by a Crash Siamese Neural Network model, comparing a first call stack matrix to a second call stack matrix. The Crash Siamese Neural Network model outputs a similarity score for the first call stack matrix and the second call stack matrix. The similarity score indicates how similar the first call stack matrix is to the second call stack matrix. The similarity indicates how likely the crashes represented by the first call stack matrix and the second call stack matrix are duplicate crashes. The similarity score is compared to a threshold to output a duplicate crash or not duplicate crash prediction.

Embodiments provide for the automation of the detection of duplicate crash failures. The automatic detection process includes the extraction of meaningful patterns, contexts, and dependencies from crash logs, thereby making the process more streamlined and efficient. Embodiments enhance code development efficiency by avoiding delays associated with determining a crash cause and reducing time required for issue resolution. Embodiments also alleviate the burden on human resources, with respect to time and knowledgebase. Embodiments may also extend beyond duplicate crash failure identification to other error analyses, including but not limited to the automatic adaptation to features of different types of errors.

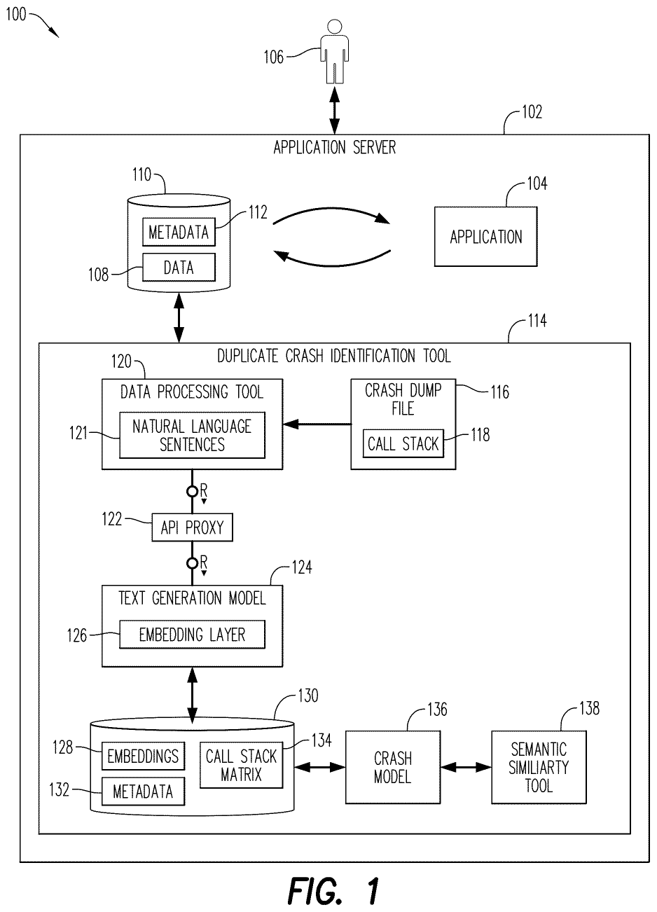

FIG. 1 is a high-level block diagram of a duplicate crash identification framework or system architecture 100 according to some embodiments. The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 100 are implemented by a single computing device, and/or two or more elements of system architecture 100 are co-located. One or more elements of system architecture 100 may be implemented using cloud-based resources, and/or other systems which apportion computing resources elastically according to demand, need, price, and/or any other metric. One or more components may be implemented as a cloud service (e.g., Software-as-a-Service, Platform-as-a-Service).

Application server 102 may comprise one or more servers, virtual machines, clusters of a container orchestration system, etc. Application server 102 may provide an operating system, services, I/O, storage, libraries, frameworks, etc. to applications executing therein.

Application 104 may comprise program code executable by a processing unit to provide functions to users such as user 106 based on coded logic and on data 108 stored in data store 110. Data 108 may comprise tabular data stored in a columnar or row-based format, object data or any other type of data that is or becomes known. Metadata 112 describes the structure and relationships of data 108 as is known in the art, including but not limited to table schemas. Data store 110 may comprise any suitable storage system such as database system, which may be partially or fully remote from application server 102, and may be distributed as is known in the art.

According to some embodiments, user 106 may interact with application 104 (e.g., via a Web browser executing a front-end UI application associated with application 104) to issue a request associated with data 108. A request may request a filtered table of data of data 108, a calculation using data of data 108, a particular visualization of data of data 108, and/or and other information that is or becomes known. To serve a received request, application 104 may generate queries of data 108 based on metadata 112 to retrieve required data. Application 104 and/or data store 110 may perform processing on data 108 prior to returning the data to user 106.

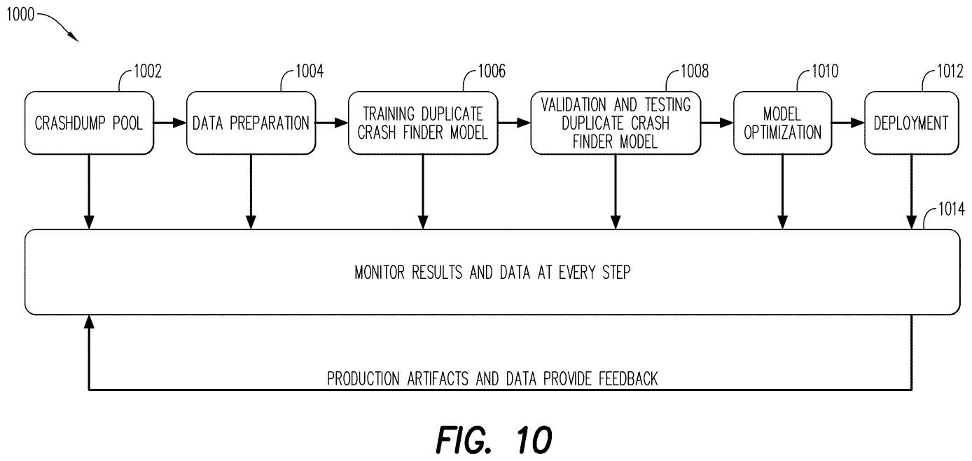

Application 104 may call duplicate crash identification tool 114 in response to a request including a crash dump file 116. The request may be received from user 106. For example, user 106 may input a given crash dump file 116 into an interface provided by application 104 and request a determination of whether this crash is a duplicate crash. The user 106 may also input the given crash dump file 116 to train a crash model 136 of the duplicate crash identification tool 114. Alternatively, the duplicate crash identification tool 114 may be executed regularly via an application 104. As a non-exhaustive example, the duplicate crash identification tool 114 may run every one minute, every two minutes, every hour, etc. as determined by an administrator. The regular execution of the duplicate crash identification tool 114 may be part of the training loop of the model pipeline, described further below with respect to FIG. 10. In some embodiments, the duplicate crash identification tool 114 may be notified of a crash by another tool. In both the scheduled execution case and the notification case, the duplicate crash identification tool 114 receives the crash dump file 116.

The crash dump file 116 including the call stack 118 is processed by a data processing tool 120 and the output of the data processing tool 120 is a natural language description of the call stack (“natural language call stack”) in the form of sentences 121.

The natural language call stack sentences (“sentence components”) 121 are then provided to Application Programming Interface (API) proxy 122 of trained text generation model 124.

Text generation model 124 may comprise a neural network trained to generate text based on input text. Trained text generation model 124 may be implemented by, for example, executable program code, a set of hyperparameters defining a model structure and a set of corresponding weights, or any other representation of an input-to-output mapping which was learned as a result of the training.

According to some embodiments, model 124 is a large language model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer 126 creates embeddings 128 from input text (natural language sentences), intended to capture the semantic and syntactic meaning of the input natural language sentences. The embedding layer 126 generates an embedding 128 (i.e., a multi-dimensional numerical vector representing the metadata) for each sentence. The embeddings 128 may be stored in a vector data store 130. The vector data store 130 may comprise a vector database in some embodiments. Vector data store 130 stores embeddings 128 representing respective instances of sentence component metadata 132. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 124 include GPT-4, LaMDA, or the like. Model 124 may be publicly available or deployed within a trusted landscape. Similarly, text generation model 124 may be trained based on public and/or private data.

The sentence vectors (embeddings) 128 for each call stack form a call stack matrix 134. The call stack matrix 134 is transmitted to the crash model 136.

The crash model 136 is a Deep Similarity (DeepSim) model—a type of machine learning model—that measures functional similarity of the vectors using a distance metric (e.g., Cosine, Euclidean, Manhattan, etc.). The DeepSim model may concatenate hidden representations learned from a target pair of matrices, effectively learning patterns between functionally similar vectors with very different syntaxes. The crash model 136 includes several layers that work together to effectively capture the latent semantic representation (a compressed, non-human interpretable, vector of information) of a pair of call stacks. The crash model 136 uses the received call stack matrix 134 as input (call stack matrix 1), along with a second call stack matrix (call stack matrix 2) from the vector data store 130, integrating deep learning models to enhance its capability in learning high-order features, modeling complex relationships, and capturing underlying associations and semantic information. Pursuant to embodiments, the architecture of the DeepSim model (crash model 136) is a Siamese Neural Network. A Siamese Neural Network uses the same structure twice—once for each of the call stack matrices—to generate representation vectors. When training a Siamese Neural Network, two or more inputs are received and the output features are compared. The comparison used in one or more embodiments is a contrastive loss comparison. The goal of contrastive loss is to train the model to put similar data closer together (i.e., minimizing their distance) and dissimilar data further away from each other (i.e., maximizing their distance). Pursuant to embodiments, the contrastive loss function calculates the Euclidean distance between vector pairs. The Euclidean distance is represented as a representation vector. It then assigns a loss value based on a predefined margin threshold. If the distance between the two vectors is less than the margin threshold, the loss value is zero. The loss is low if positive samples are encoded to similar (closer) representations and negative examples are encoded to different (farther) representations. Euclidean distance is a distance metric used in machine learning to measure dissimilarity. Euclidean distance focuses on magnitude, measuring the straight-line distance between two points in space.

The representation vectors are received by a Semantic Similarity tool 138. The Semantic similarity tool 138 calculates a cosign similarity of the two call stacks using the representation vectors. Cosine similarity is a distance metric used in machine learning to measure dissimilarity. Cosine similarity measures the similarity between two vectors by calculating the cosine of the angle between them in a multi-dimensional space. The output of the cosign similarity calculation is compared to a threshold value. Based on the comparison, the crash for call stack 1 is either a non-duplicate crash or a duplicate crash of the crash for call stack 2.

Implementation of the architecture 100 includes storing representation vectors of crash failures generated by the crash model 136 in the vector data store 130. Subsequently, based on actions (e.g., input crash dump file of crash failures, search duplicate crash failures) from a front end (e.g., a user interface), APIs are invoked from the back end (e.g., application server 102 including the duplicate crash identification tool 114) to extract and save representations of crash failures from the data store 110 and the vector data store 130, calculate the similarity of crash failures and detect duplicate crash failures. Concurrently, processes are performed to handle duplicate crashes, ensuring comprehensive performance of the duplicate crash identification tool 114.

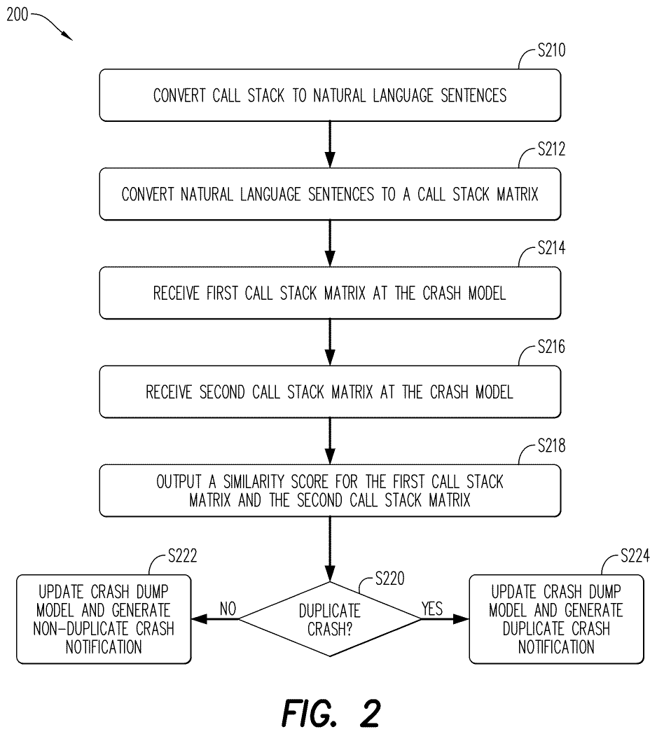

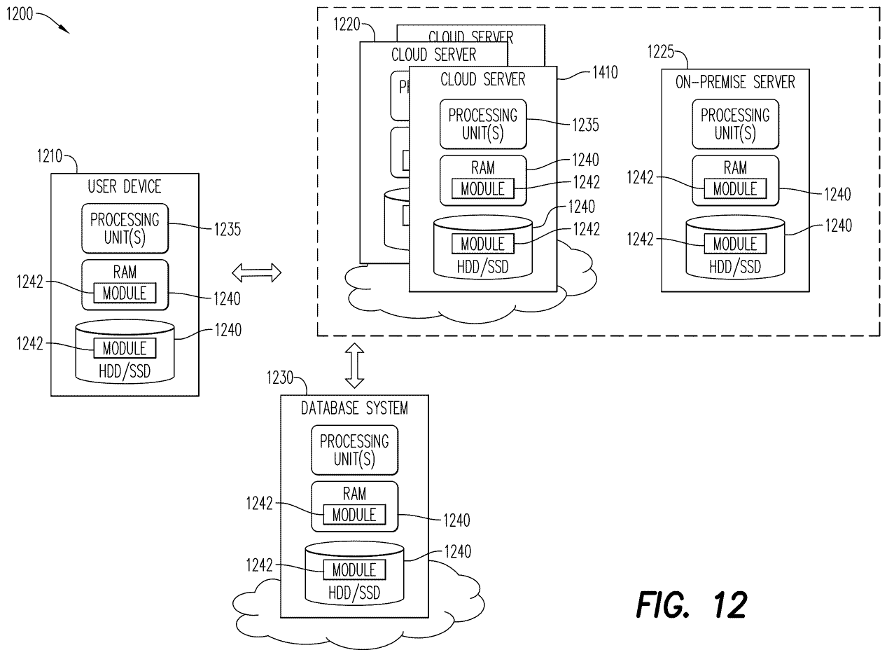

FIG. 2 illustrates a process 200 to train the crash model 136 according to some embodiments. The process 200, and other processes described herein (e.g., 300, 600, 800), may be performed by a database node, a cloud platform, a server, a computing system (user device), a combination of devices/nodes, or the like, according to some embodiments. In one or more embodiments, the system architecture 100 may be conditioned to perform the process 200, and other processes described herein (e.g., 300, 600, 800), such that a processing unit 1235 (FIG. 12) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to the start of the process, one or more crash dump files have been stored as data 108 in data store 110. As described above, generation of the crash dump file may be triggered by a crash.

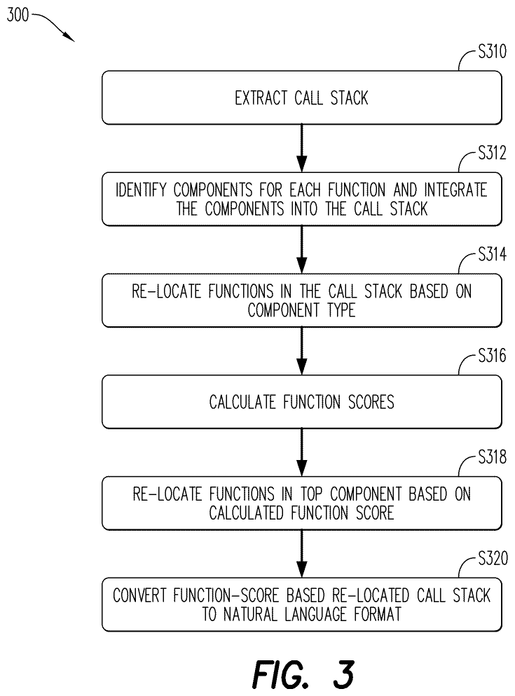

Initially, at S210, the call stack 118 included in the crash dump file 116 is converted to a natural language call stack (natural language sentences 121) by the data processing tool 120, as described further below with respect to FIGS. 3, 4, and 5.

Then at S212, the natural language sentences 121 are received by the text generation model 124 and converted to a call stack matrix 134.

Next, the call stack matrix 134, referred to as the first call stack matrix 134, is received by the crash model 136 at S214. At S216, the crash model 136 receives a second call stack matrix. The second call stack matrix is from a second crash dump file that is different from the crash dump file the first call stack matrix was derived from. The first call stack matrix and the second call stack matrix are compared at S218 to output a similarity score indicating how similar the first call stack matrix is to the second call stack matrix. It is then determined at S220 whether the crash recorded in the first crash dump file is a duplicate of the crash recorded in the second crash dump file by comparing the similarity score to a threshold level. In a case it is determined the first crash is not a duplicate of the second crash at S220, the process proceeds to S222, and the crash dump model 136 is updated and a non-duplicate crash notification is generated indicating the crash is not a duplicate and a crash source needs to be identified. In a case it is determined the first crash is a duplicate of the second crash at S220, the crash dump model 136 is updated and a duplicate crash notification is generated indicating the crash is a duplicate and including the remediation for this crash at S224.

FIG. 3 illustrates a process 300 to convert the call stack to a natural language sentence according to some embodiments.

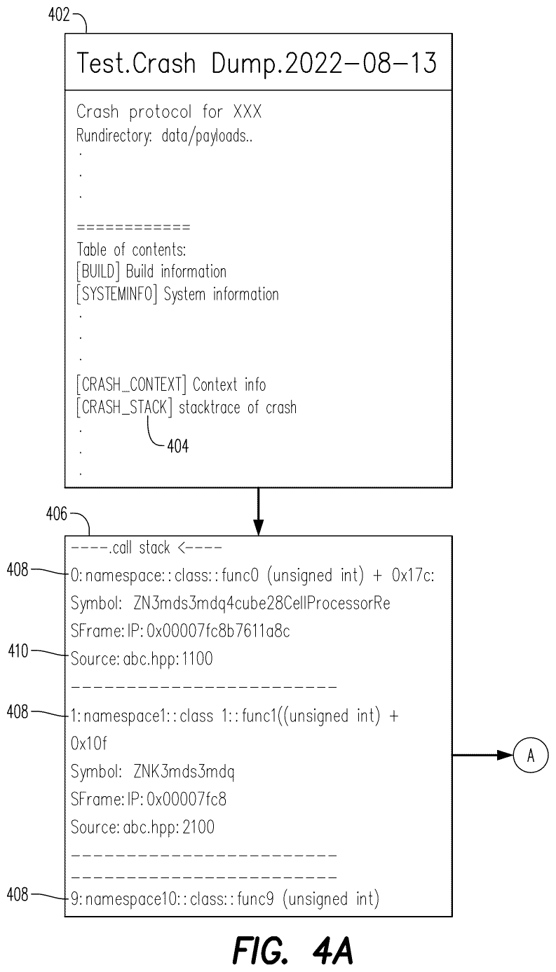

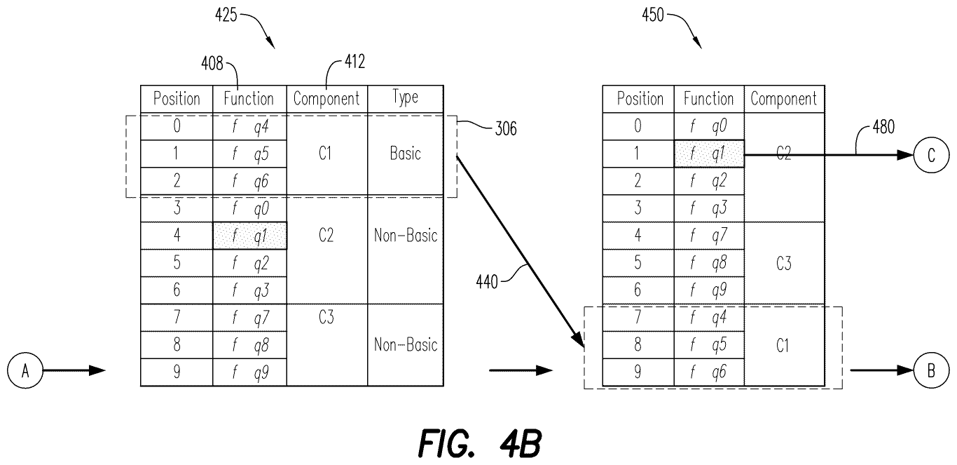

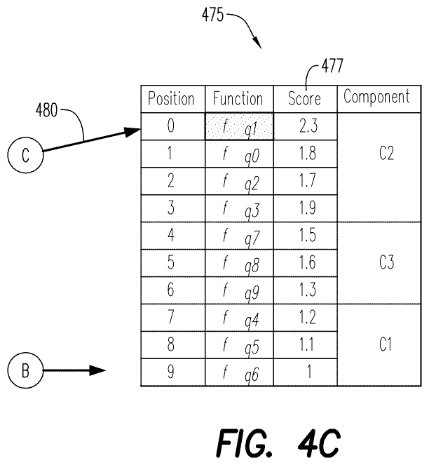

Initially, at S310, the call stack 406 (FIG. 4A) is extracted from the crash dump file 402 (FIG. 4A) and received at the data processing tool 120. The extracted call stack retains function positions and names while filtering out extraneous details. The crash stack 404 of the crash dump file 402 is extracted as the call stack 406. As described above, the call stack 406 includes one or more functions 408, and lists the functions in the order they were called/executed.

Then in S312, components 412 are identified for each function and integrated into the call stack, shown at 425 (FIG. 4B). In embodiments, each function 408 in the call stack 406 lists a source file 410. The data 108 of data store 110 includes a mapping of the source file 410 to a component 412.

Each component 412 is classified by type (Basic or Non-Basic). The classification is based on analysis of the frequency of crashes occurring in different components. Components having lower issue frequencies are classified as Basic. Conventionally, the top function in the call stack is assumed to be highly relevant to the root cause, having a higher frequency of crashes and therefore conventionally classified as Basic. However, the inventors note that while certain conventionally classified “Basic” components frequently appear at the beginning of call stacks and account for 51% of crashes, they only account for 6% of coding errors. As these conventionally typed Basic components typically represent stable, low-level code, the call stack is adjusted in S314 by re-locating the functions from the Basic component to lower positions. The re-location prioritizes functions more likely associated with the root cause by moving those functions to higher positions (e.g., the higher the position, the more closely related to the root cause), and enhances the accuracy of identifying the root cause.

As shown in FIG. 4B, the functions 408 of the C1 component are re-located in S314 (indicated by arrow 440) from the top of the call stack 425 to the bottom of the call stack 450. The re-location changes the position of the functions in the call stack. Continuing with our non-exhaustive example, function ƒ_{q4} was position 0 in the call stack at 425. The re-location changes the position of function ƒ_{q4} to position 7, as shown in the call stack 450.

Then, at S316, a function score 477 is calculated for each function. To further enhance the determination of the relevance of functions in the call stack to the root cause, embodiments apply Term Frequency-Inverse Document Frequency (TF-IDF) to generate the function score 477. TF-IDF is the calculation of how relevant a word in a series or data-set is to a text. The meaning increases proportionally to the number of times in the text a word appears but is compensated by the word frequency in the data-set. Embodiments use Equation 1 to compute function scores:

$${Function\_score}_{x , y} = t {f}_{x , y} \times log ( \frac{N}{{df}_{x}} ) \qquad Equation 1$$

Here, “tf_{x,y}” represents the frequency of function “x” in call stack “y”, “dfₓ” indicates the occurrence count of the function “x” across all call stacks, and “N” is the total number of call stacks.

Equation 1 may be coded as:

$$∖ beg in \{ equation \}$$

$$∖ text {\{ Function ∖ \_score \}}_{-} \{ x , y \} = tf\_ \{ x , y \} \backslash times ∖ log ∖ left ( ∖ frac \{ N \} \{ df\_x \} ∖ right )$$

$$∖ label \{ tfidf \}$$

$$∖ end \{ equa t ion \}$$

The calculated function scores 477 guide the selection of the most relevant function as the potential root cause. In particular the higher the function score, the more related the function is to the root cause. In S318, the function having the highest function score in the top component is re-located to the first position (position 0) in the call stack. It is noted that the function scores for the functions in the other (non-top) components do not cause re-location of the function positions to minimize the risk of errors or code instability (e.g., some functions depend on other functions, and changing the position may result in a function sequence that is not useful for its intended purpose). Continuing with the non-exhaustive example shown in FIG. 4C, within the C2 component (the top component), the highest function score (2.3) is calculated for function ƒ_{q1}. However, function ƒ_{q1} is positioned at position 1 in 450, as indicated by the shading. In S318, function ƒ_{q1} is re-located to position 0, indicated by arrow 480, shown in call stack 475 (FIG. 4C).

The inventors note, by integrating basic components and function scores to re-locate the functions in the call stack, the functions most pertinent to the root cause are prioritized while mostly preserving the original structure to minimize the risk of errors or instability. These re-locations significantly improve the localization of root functions. In some cases, the re-location increases the proportion of first functions belonging to the root cause from 56% to 70%.

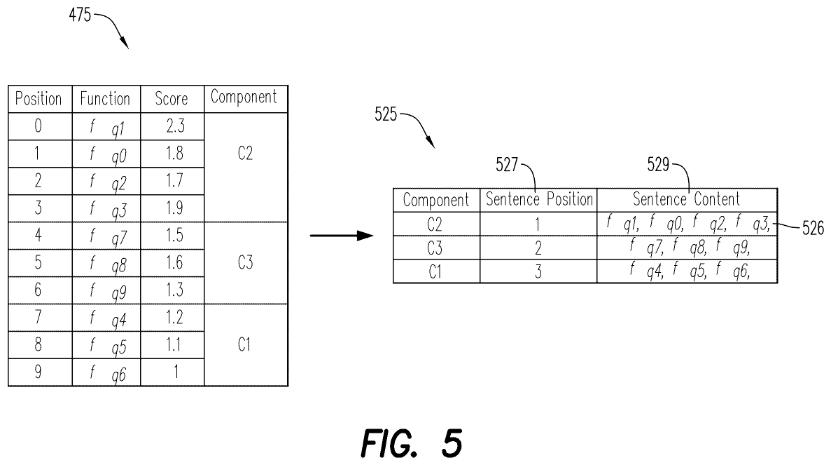

Turning back to the process 300, in S320, the function-score based re-located call stack 475 is converted to a natural language format, and in particular, to natural language sentences 526 (FIG. 5) representing the components. The functions corresponding to each component are aggregated (e.g., merged) in sequential order, forming a coherent sentence. This process accomplishes the transformation of the call stack into a natural language format. Continuing with the non-exhaustive example, the four functions from C2 are merged into the first sentence position 527, having a sentence content 529 of ƒ_{q1}, ƒ_{q0}, ƒ_{q2}, ƒ_{q3} as shown in call stack 525 (FIG. 5). The sentence content 529 is the functions that form the natural language sentence 526. Every component will have a sentence content 529 following S320. Consequently, a call stack is converted into multiple sentences composed of its constituent components.

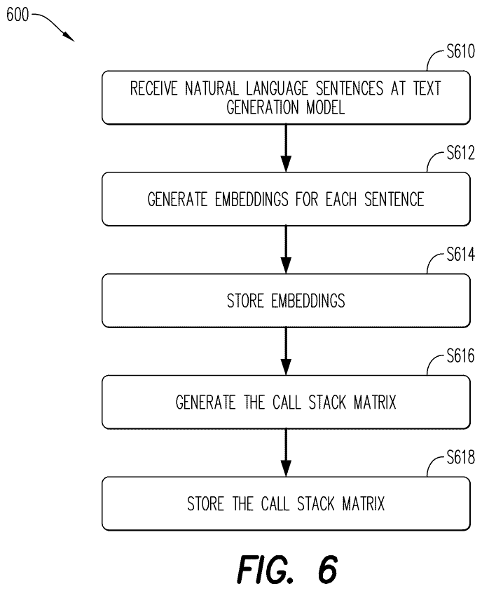

FIG. 6 illustrates a process 600 to generate a call stack matrix according to some embodiments.

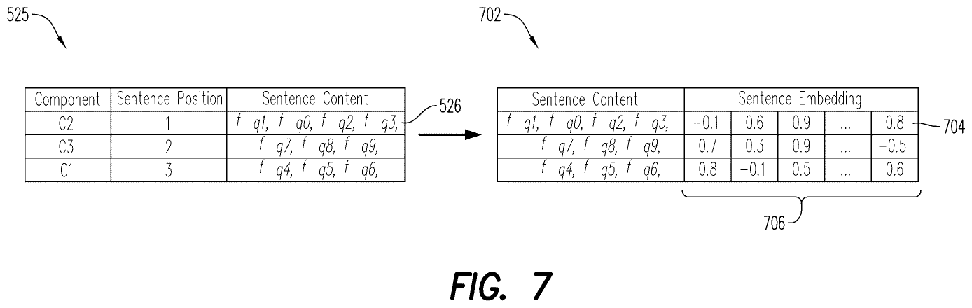

Initially, at S610, the natural language sentences 526 are received at the trained text generation model 124 via the API proxy 122. Then at S612 embeddings 704 (FIG. 7) are generated via the embedding layer 126. The embedding layer 126 executes an embedding process to represent objects (in this case the natural language sentences) as mathematical vectors. As described above, an embedding is a multi-dimensional numerical vector representing the metadata for each sentence. The embedding is created by translating the sentence into a mathematical form based on its traits, categories and other suitable factors. With respect to the natural language sentences, the functions (sentence content) with similar meanings will have similar embeddings. Pursuant to embodiments, the embedding layer 126 of the text generation model 124 embeds functions corresponding to each component of the call stack (per the natural language sentences) into a semantic latent space. Mathematically, the embedding may be expressed as

$${Embedding}_{callstack} = {LLM}_{embedding} ( {functions}_{callstack} )$$

The semantic latent space is a lower-dimensional representation of high-dimensional data (which is a form of data compression) that's used to simplify complex data structures and reveal hidden patterns. In latent space, similar data points are closer together, while dissimilar ones are farther apart.

Continuing with the non-exhaustive example, embeddings 704 are generated for the sentence content 529, as shown in 702 (FIG. 7), resulting in sentence vectors

In S614, the embeddings are stored in the vector data store 130.

In S616, the sentence vectors are sequentially merged to generate a structure known as the call stack matrix 706 (FIG. 7). The call stack matrix 706 serves as an input parameter for the crash model 136 to generate representation vectors of the call stack.

Then, in S618, the call stack matrix 706 is stored in the vector data store 130.

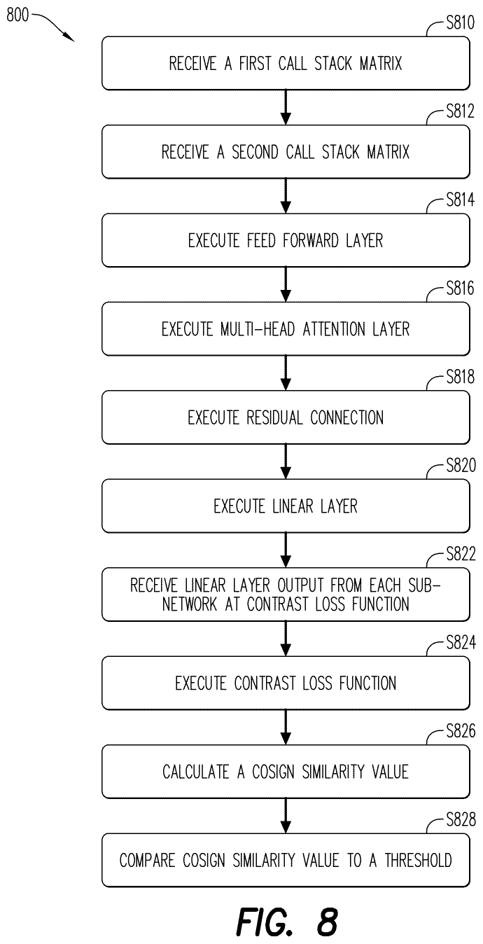

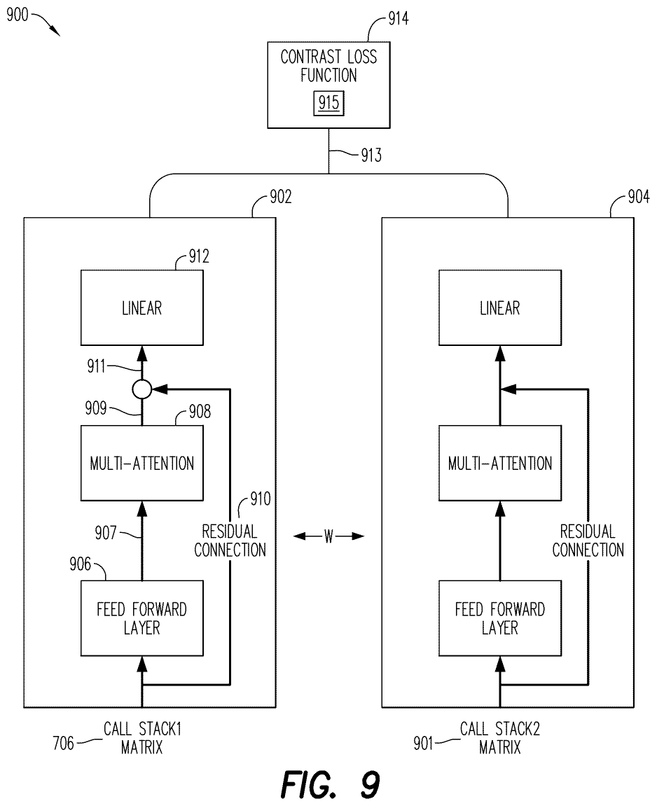

Turning to FIG. 8, a process 800 for determining a similarity between crashes is provided according to some embodiments. The process 800 references the architecture of the crash model, which will first be described with respect to FIG. 9 to facilitate the discussion of the process 800.

FIG. 9 illustrates the architecture of the crash model 900. Because the crash model 900 has a Siamese Neural Network architecture, the crash model 900 includes two identical sub-networks—902 and 904—to calculate the similarity between two inputs. The two identical sub-networks—902 and 904—have the same parameters, and same weight (w) sharing. Each sub-network takes in a respective, different, input and uses the same weights to compute comparable output vectors. Each sub-network includes a feed forward layer 906, a multi-attention layer 908, a residual connection element 910, and a linear layer 912. The crash model 900 also includes a contrast loss calculation function 914 that receives the output of both sub-networks, as described further below.

As described above, the crash model 900 is a Deep Similarity (DeepSim) model—a type of machine learning model—that measures functional similarity of the vectors using a distance metric (e.g., Cosine, Euclidean, Manhattan, etc.). The crash model 900 includes several layers that work together to effectively capture the latent semantic representation (a compressed, non-human interpretable, vector of information) of a pair of call stacks. Pursuant to embodiments, the architecture of the crash model 900 is a Siamese Neural Network.

Initially, at S810, a first call stack matrix is received at the first sub-network 902 of the crash model 900. The first call stack matrix is the call stack matrix 706 generated at S616. A second call stack matrix 901 is received at the second sub-network 904 of the crash model 900 at S812. The second call stack matrix 901 represents a crash for which an output (e.g., representation vector) of the linear layer of the second sub-network has been pre-computed. The pre-computation allows the output of the linear layer of the second sub-network to form a baseline for comparison of the output of the linear layer of the first sub-network. It is noted that while only one comparison is shown herein (e.g., first call stack matrix compared to second call stack matrix), the first call stack matrix may be compared to every pre-computed representation vector to determine whether the first call stack matrix represents a duplicate crash stored in the vector data store 130.

The following steps S812-S820 will be described with respect to the first sub-network 902, noting the steps are the same for the second sub-network 904. As further noted, in some instances the steps for the second sub-network are executed prior to the steps for the first sub-network 902. In other instances, the steps for both the first sub-network and the second sub-network are executed at a same time or substantially the same time.

After the first and second call stacks are received at S810 and S812, respectively, the feed forward layer 906 is executed at S814, introducing non-linear transformations to the first call stack matrix 706, and resulting in a feed forward layer output 907. The feed forward layer output 907 may be a compressed call stack matrix. The non-linear transformations aid the crash model in learning high-order features of the data. The feed forward layer 906 is composed of multiple fully-connected layers that transform the first call stack matrix by extracting key information from the first call stack matrix. As a non-exhaustive example, the vector represented by the call stack matrix may be very long (e.g., with four thousand zeros). Of that vector, the key features represent one thousandth of that vector.

Next, the feed forward layer output 907 is further transformed by execution of the multi-head attention layer 908 at S816. The multi-head attention layer 908 allows the sub-network 902 to focus on information from different positions, enhancing the network's capability to model complex relationships between different functions in the call stack. The multi-head attention layer 908 employes multiple attention head mechanisms in parallel to process the feed forward layer output 907. Each head focus on different parts of the input. The outputs from each head are then combined to create a final attention score output 909.

Execution of the residual connection element 910 adds the embedding vectors from the first call stack matrix to the final attention score output 909 in S818 to form the residual connection output 911. The residual connection element 910 helps to keep some key features that may have been dropped from the call stack matrix during execution of the feed forward layer 906 and multi-head attention layer 908 and provide these key features as input to the linear layer. The residual connection element 910 helps alleviate the vanishing gradient problem, promoting the flow of information and enhancing the robustness of deeper network representations.

The residual connection output 911 is converted into a vector via execution of the linear layer 912 at S820. The linear layer 912 employes linear transformations to convert, via a weighted sum, the residual connection output 911 into the network's representation vector as the linear layer output 913.

The linear layer output 913 from each of the first sub-network 902 and the second sub-network 904 is received by the contrast loss function 914 at S822. Execution of the contrast loss function 914 at S824 outputs a contrast loss function output 915. The contrast loss function output 915 is representation vectors representing the loss values for the comparison.

As described above, the contrast loss function 914 ensures the crash model 136 can discern differences between duplicate and non-duplicate call stacks. The contrast loss function 914 may be expressed by Equation 2 as follows:

$$ℒ = \frac{1}{2 N} {\sum }_{i = 1}^{N} ( {Y}_{i} {d}_{i}^{2} + ( 1 - {Y}_{i} ) {max ( 0 , margin - {d}_{i} )}^{2} ) \qquad Equation 2$$

where “N” is the batch size, “Yᵢ” is the binary label, and “dᵢ” is the Euclidean distance between the Siamese networks representation vectors.

Equation 2 may be coded as:

$$∖ beg in \{ equation \}$$

$$∖ mathcal \{ L \} = ∖ frac \{ 1 \} \{ 2 N \} ∖ sum\_ \{ i = 1 \} ⋀ N ∖ left ( Y\_i d\_i ⋀ 2 + ( 1 - Yi\_ ) ∖ max ( 0 , ∖ text \{ margin \} - d\_i ) ⋀ 2 ∖ right )$$

$$∖ label \{ contrastive \}$$

$$∖ end \{ equa t ion \}$$

The representation vectors are received by a Semantic Similarity tool 138. The Semantic similarity tool 138 calculates a cosign similarity value of the two call stacks using the representation vectors in S826. The cosign similarity value of the call stacks using the representation vectors is expressed in Equation 3 as follows:

$$Cosine Similarity ( {callstack}_{1} , {callstack}_{2} ) = \frac{{callstack}_{1} \cdot {callstack}_{2}}{‖ {callstack}_{1} ‖ \cdot ‖ {callstack}_{2} ‖} \qquad Equation 3$$

The cosign similarity value is output from the cosign similarity calculation per Equation 3. The cosign similarity value is compared to a threshold value at S828. Based on the comparison, the crash for call stack 1 is either a non-duplicate crash issue or a duplicate crash issue. As a non-exhaustive example, in a case the cosign similarity score is above the threshold, call stack 1 and call stack 2 have duplicate root causes; and in a case the cosign similarity score is below the threshold, call stack 1 and call stack 2 do not have duplicate root causes.

FIG. 10 is a model pipeline 1000 according to embodiments. The model pipeline 1000 may be employed for automatic crash model management. Initially, at 1002, historical crash dump data from one or more crash dumps is acquired and stored as a crash dump pool. Data preparation is executed on the historical crash dump data at 1004 to extract and generate the necessary data format. Subsequently, based on the dataset and the crash model design, training the crash model 1006 with the data in the necessary format, validation and testing of the crash model 1008, and model optimization 1010 to attain the best model are executed. Following this, the crash model is deployed 1012 into a production environment. The results of the deployed crash model and data are monitored 1014 at every step via a monitoring script. Continuous monitoring of the data generated in the production environment, and assessment of its accuracy, provides for an ongoing and automatic feedback loop in one or more embodiments. Utilizing the data and model performance metrics derived from the production environment, the crash model is iteratively retrained, establishing an effective feedback loop. As a non-exhaustive example, metrics like the amount of available data and/or a performance metric may automatically trigger execution of the pipeline. Other suitable metrics may be used to trigger execution of the pipeline.

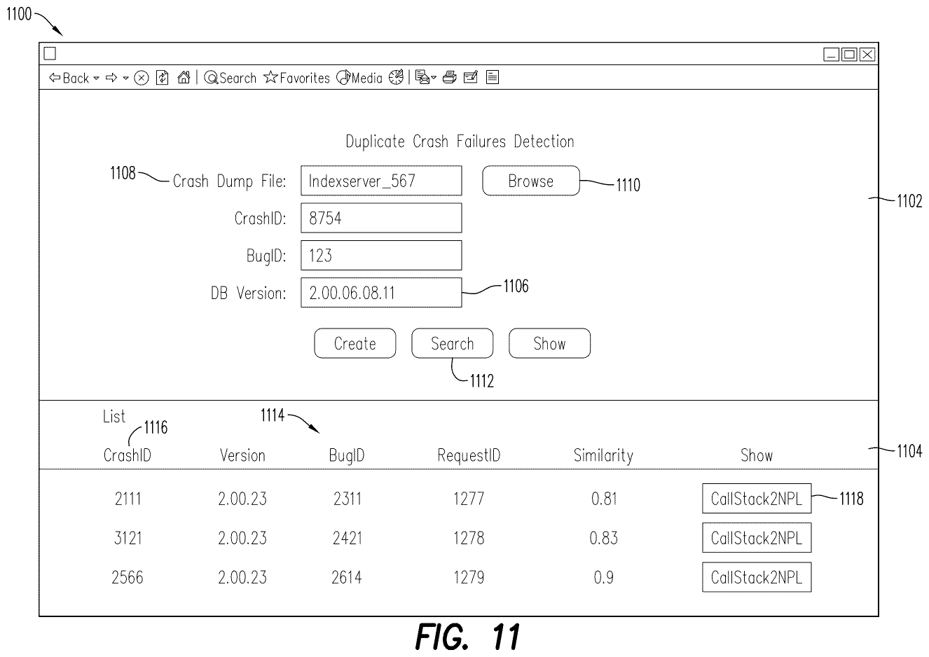

FIG. 11 is a non-exhaustive example of a user interface 1100 to determine whether a crash having a given crash dump file is a duplicate crash. The user interface 1100 may include an input pane 1102 and an output pane 1104. The input pane 1102 includes user entry fields 1106 for the following parameters 1108: crash dump file, crash ID, bug ID, DB version. The value for the crash dump file indicates which crash dump file to upload to the duplicate crash identification tool 114 as described above. A browse control 1110 may be selected to search for a crash dump file. Pursuant to some embodiments, a search for a duplicate crash dump file may be executed with less than all of the user entry fields having values therein. Selection of the search control 1112 executes the processes described herein to: generate a representation vector for the selected crash dump file; compare that representation vector to the representation vectors for the crash dumps already processed by the duplicate crash identification tool 114; and then use the threshold value to determine whether the representation vector for the uploaded crash dump file is a duplicate. In response to execution of the processes, a table 1114 is populated in the output pane 1104. The table 1114 includes the following columns 1116: CrashID, Version, BugID, RequestID, Similarity and Show. Other suitable columns may be included. The Similarity parameter 1116 is the cosine similarity score calculated at S816. The values in the Show column include CallStack2NPL controls 1118. Selection of the CallStack2NPL control 1118 generates a pop-up window (not shown) displaying the natural language sentences output in S320, as described above.

FIG. 12 illustrates a cloud-based database deployment 1200 according to some embodiments. The illustrated components may reside in one or more public clouds providing self-service and immediate provisioning, autoscaling, security, compliance and identity management features.

User device 1210 may interact with applications executing on one of the cloud server 1220 or the on-premise server 1225, for example via a Web Browser executing on user device 1210, in order to train a crash model and identify a duplicate crash failure. Database system 1230 may store data as described herein to train a crash model and identify a duplicate crash failure. Cloud server 1220 and database system 1230 may comprise cloud-based compute resources, such as virtual machines, allocated by a public cloud provider. As such, cloud server 1220 and database system 1230 may be subjected to demand-based resource elasticity. Each of the user device 1210, cloud server 1220, and on-premise server 1225 and database system 1230 may include a processing unit 1235 that may include one or more processing devices each including one or more processing cores. In some examples, the processing unit 1235 is a multicore processor or a plurality of multicore processors. Also, the processing unit 1235 may be fixed or it may be reconfigurable. The processing unit 1235 may control the components of any of the user device 1210, cloud server 1220, on-premise application server 1225, and database system 1230. The storage devices 1240 may not be limited to a particular storage device and may include any known memory device such as RAM, ROM, hard disk, and the like, and may or may not be included within a database system, a cloud environment, a web server or the like. The storage device 1240 may store software modules or other instructions/executable code which can be executed by the processing unit 1235 to perform the method shown in FIGS. 2/3/6/8. According to various embodiments, the storage device 1240 may include a data store having a plurality of tables, records, partitions and sub-partitions. The storage device 1240 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
a data store storing one or more crash dump files;
a memory storing program code; and
one or more processing units to execute the program code to cause the system to:
receive a crash dump file;
extract a call stack from the received crash dump file, wherein the call stack includes one or more functions, the functions having ordered positions in the call stack;
convert the extracted call stack to natural language sentences;
convert the natural languages sentences to a first call stack matrix;
receive the first call stack matrix and a second call stack matrix at a crash model;
determine a similarity score for the first call stack matrix and the second call stack matrix; and
determine whether the first call stack matrix and the second call stack matrix represent duplicate crashes based on the similarity score.

2. The system of claim 1, wherein conversion of the extracted call stack to natural language sentences further comprises processor executable code to cause the system to:
identify a component mapped to each function;
re-locate ordered positions of functions in the call stack based on a component type and a function score, forming a modified call stack; and
convert the modified call stack to natural language sentences representing one or more components.

3. The system of claim 2, wherein each function includes a source file name and the source file name is mapped to the component.

4. The system of claim 2, wherein positions of function calls in the call stack are re-located a first time based on the component type and re-located a second time based on function score.

5. The system of claim 4, wherein the first time re-location further comprises program code to:
move the component having a basic component type to a top location in the order in the call stack, wherein moving the component moves the function calls for the functions mapped to the component.

6. The system of claim 4, wherein the function score is generated for each function via term frequency-inverse document frequency (TF-IDF).

7. The system of claim 1, wherein conversion of the natural languages sentences to a first call stack matrix further comprises processor executable code to cause the system to:
receive the natural language sentences at a text generation model;
generate an embedding for each sentence, forming sentence vectors; and
sequentially merge the sentence vectors, forming the first call stack matrix.

8. The system of claim 7, wherein the text generation model is a large language model (LLM).

9. The system of claim 1, wherein the crash model is a Siamese neural network model.

10. The system of claim 9, wherein the Siamese neural network model includes a feed forward layer a multi-head attention layer, a residual connection and a linear layer.

11. The system of claim 10, further comprising processor-executable steps to cause the system to:
receive an output of the linear layer for each of the first call stack matrix and the second call stack matrix at a contrast loss function;
execute the contrast loss function, wherein an output of the contrast loss function is a representation vector;
receive the representation vector at a semantic similarity tool; and
generate a cosine similarity value, via the semantic similarity tool, wherein the cosine similarity value is the similarity score.

12. A computer-implemented method comprising:
receiving a crash dump file;
extracting a call stack from the received crash dump file, wherein the call stack includes one or more functions, the functions having ordered positions in the call stack;
converting the extracted call stack to natural language sentences;
converting the natural languages sentences to a first call stack matrix;
receiving the first call stack matrix and a second call stack matrix at a crash model, wherein the crash model is a Siamese neural network model;
determining a similarity score for the first call stack matrix and the second call stack matrix; and
determining whether the first call stack matrix and the second call stack matrix represent duplicate crashes based on the similarity score.

13. The method of claim 12, wherein conversion of the extracted call stack to natural language sentences further comprises:
identifying a component mapped to each function;
re-locating ordered positions of functions in the call stack based on a component type and a function score, forming a modified call stack; and
converting the modified call stack to natural language sentences representing one or more components.

14. The method of claim 13, wherein re-locating the ordered positions further comprises:
moving the component having a basic component type to a top location in the order in the call stack, wherein moving the component moves the function calls for the functions mapped to the component.

15. The method of claim 12, wherein conversion of the natural languages sentences to a first call stack matrix further comprises:
receiving the natural language sentences at a text generation model;
generating an embedding for each sentence, forming sentence vectors; and
sequentially merging the sentence vectors, forming the first call stack matrix.

16. The method of claim 12, wherein the Siamese neural network model includes a feed forward layer a multi-head attention layer, a residual connection and a linear layer.

17. The method of claim 16, further comprising:
receiving an output of the linear layer for each of the first call stack matrix and the second call stack matrix at a contrast loss function;
executing the contrast loss function, wherein an output of the contrast loss function is a representation vector;
receiving the representation vector at a semantic similarity tool; and
generating a cosine similarity value, via the semantic similarity tool, wherein the cosine similarity value is the similarity score.

18. One or more non-transitory, computer-readable medium storing instructions, that, when executed by a computing system, cause the computing system to perform operations comprising:
receiving a crash dump file;
extracting a call stack from the received crash dump file, wherein the call stack includes one or more functions, the functions having ordered positions in the call stack;
converting the extracted call stack to natural language sentences;
converting the natural languages sentences to a first call stack matrix;
receiving the first call stack matrix and a second call stack matrix at a crash model, wherein the crash model is a Siamese neural network model;
determining a similarity score for the first call stack matrix and the second call stack matrix; and
determining whether the first call stack matrix and the second call stack matrix represent duplicate crashes based on the similarity score.

19. The media of claim 18, wherein conversion of the extracted call stack to natural language sentences further comprises:
identifying a component mapped to each function;
re-locating ordered positions of functions in the call stack based on a component type and a function score, forming a modified call stack; and
converting the modified call stack to natural language sentences representing one or more components.

20. The media of claim 18, further comprising:
receiving an output of a linear layer, of the Siamese neural network, for each of the first call stack matrix and the second call stack matrix at a contrast loss function;
executing the contrast loss function, wherein an output of the contrast loss function is a representation vector;
receiving the representation vector at a semantic similarity tool; and
generating a cosine similarity value, via the semantic similarity tool, wherein the cosine similarity value is the similarity score.
